(19) United States
(12) Patent Application Publication
(10) Pub. No.: US 2016/0366395 A1
(43) Pub. Date: Dec. 15, 2016

(54) LED SURFACE EMITTING STRUCTURED LIGHT

(71) Applicant: Microsoft Technology Licensing, LLC, Redmond, WA (US)

(72) Inventors: Samuli Wallius, Turku (FI); Mikko Juhola, Salo (FI)

(21) Appl. No.: 14/737,920

(22) Filed: Jun. 12, 2015

(51) Int. Cl. H04N 13/02; H04N 5/225; G06T 7/00; G06K 9/20; F21V 5/04; G03B 15/03

(52) U.S. Cl. CPC H04N 13/0271; F21V 5/048; G03B 15/03; G06T 7/0051; G06K 9/2036; H04N 5/2256; F21Y 2101/02

(57) ABSTRACT

Structured light is produced by utilizing the surface structure of a light emitting diode. A lens is positioned at a distance of a focal or hyperfocal length from the surface. The surface of the light emitting diode has light emitting areas and other structures, such as conductors that do not emit light. This contrast is projected as structured light.

### BACKGROUND

Structured light is used to project a predefined pattern on an object or surface. Structured light deforms when striking surfaces or objects, thereby allowing the calculation of for example the depth or surface information of the objects. Structured light may also be used for measuring a distance or a shape of a three-dimensional object. Structured light systems may comprise a light projector and a camera module. Examples of known devices producing structured light are laser systems or LED projectors with pattern masks and optics.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Structured light is produced by utilizing the surface structure of a light emitting diode. A lens is positioned at a distance of a focal or hyperfocal length from the surface. The surface of the light emitting diode has light emitting areas and other structures, such as conductors that do not emit light. This contrast is projected as structured light.

Many of the attendant features will be more readily appreciated as they become better understood by reference to the following detailed description considered in connection with the accompanying drawings. The embodiments described below are not limited to implementations which solve any or all of the disadvantages of known imaging apparatuses integrated in hand-held devices.

### DESCRIPTION OF THE DRAWINGS

The present description will be better understood from the following detailed description read in light of the accompanying drawings, wherein:

FIG. 1 is a schematic diagram of one example of an electronic device incorporating a light emitting diode;

FIG. 2 is a schematic diagram of one example of a light emitting diode and a projecting lens;

FIG. 3 is a schematic diagram of one example of a light emitting diode having a surface structure;

FIG. 4 is a schematic diagram of another example of a light emitting diode having a surface structure;

FIG. 5 is a schematic flowchart illustrating one embodiment of a method for manufacturing an apparatus;

FIG. 6 is a schematic flowchart illustrating one embodiment of a method for manufacturing an apparatus;

FIG. 7a is a schematic diagram of one step of a method for calibrating the system or apparatus; and

FIG. 7b is a schematic diagram of another step of a method for calibrating the system or apparatus.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. However, the same or equivalent functions and sequences may be accomplished by different examples.

Although the present examples are described and illustrated herein as being implemented in a smartphone, the device described is provided as an example and not a limitation. As those skilled in the art will appreciate, the present examples are suitable for application in a variety of different types of mobile and/or hand-held apparatuses, e.g. in tablets, laptops or gaming consoles. Structured light may be used in various applications and apparatuses utilizing a depth camera functionality.

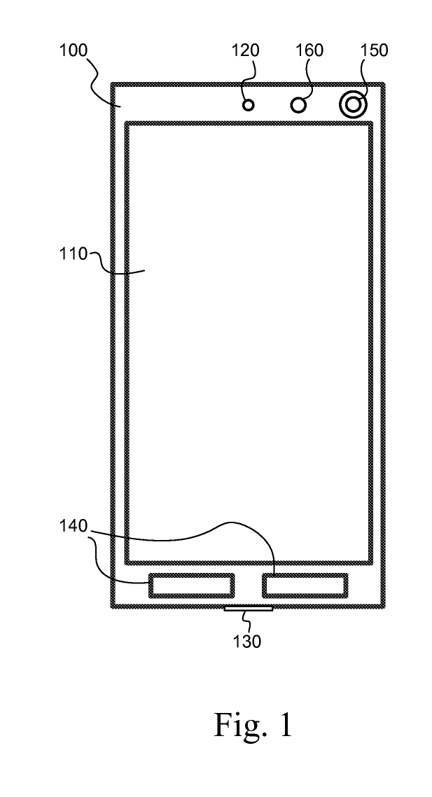

FIG. 1 shows one example of an electronic device incorporating an imaging apparatus and a light emitting diode, wherein one embodiment of the electronic device is a smartphone. The electronic device comprises a body 100 comprising a display 110, a speaker 120, a microphone 130 and keys 140. The display is usually on the front side of the electronic device. The electronic device comprises an imaging apparatus 150, a camera. A light emitting diode, LED, 160 is positioned on the front side in this example, but it may be positioned on any side of the apparatus. The LED 160 may be used as a flashlight for the camera 150 or it may emit structured light. The camera 150 may function as a depth camera, as the LED 160 projects a predefined structured light pattern on the imaging area.

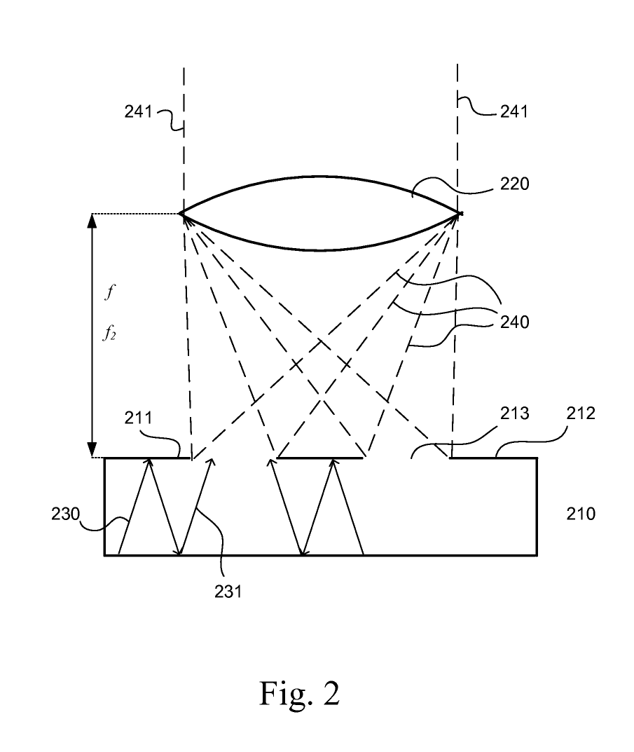

FIG. 2 shows one example of a light emitting diode LED 210 of an apparatus. The LED 210 has a surface 211 that allows rays of light to travel from the LED 210. A projecting lens 220 is positioned at a focal distance f from the surface 211 of the LED 210, as illustrated by the dashed lines 240. In one embodiment the projecting lens 220 is a collimating lens, a collimator that may consist of a curved lens with the surface 211 of the LED 210 at its focus and replicate an image of the LED surface 211 into infinity without a parallax. The projecting lens 220 projects the image of the LED surface 211 along the dashed lines 241. In one embodiment the projecting lens 220 is positioned at a hyperfocal distance f₂ from the surface 211 of the LED 210. The hyperfocal distance may be defined as the closest distance at which a lens can be focused while keeping objects into infinity acceptably sharp. The hyperfocal distance may also be defined as the distance beyond which all objects are acceptably sharp, for a lens focused into infinity.

The LED 210 is a two-lead semiconductor light source. It is a pn-junction diode, which emits light when activated. According to one example, photons 230 reflect from a reflective inner surface, unless they reach a transparent portion 213 of the surface 211, and the light 231 is emitted out of the LED. The surface 211 of the LED 210 has different structures, for example formed by a conductor surface 212 and a light emitting surface 213. The light 231 is emitted from the light emitting surface 213—as the conductor surface 212 does not emit light, the surface 211 of the LED 210 has a high contrast area that has several distinguishable features. The light from the light emitting surface 213 travels via the projecting lens 220. As the distance between the surface 211 and the projecting lens 220 equals the focal length f or hyperfocal length f₂, the contrast between the light emitting surface 213 and the conductor surface 212 is clearly visible in the projection. The contrast edges in the projected LED surface 211 image form the structured light. In one example where the electronic device is a smartphone, the distance f or f₂ between the projecting lens 220 and the surface 211 of the LED 210 is between 6 mm and 3 mm, but other embodiments may be implemented with different focal distances or with different electronic apparatuses such as gaming consoles, hand-held devices, tablets or cameras.

The structured light may be used to project a known pattern on a scene. The way that it deforms when striking surfaces allows an imaging apparatus such as a camera to acquire an image, and the apparatus may calculate the depth or surface information of the objects in the scene. One example is a structured light 3D scanner or a gaming console. A depth camera may be used to capture 3D motion or movements of the user or detect gestures in the imaging area. The structured light may be projected in visible light or imperceptible light in the visible light wavelengths, for example by fast blinks in frame rates that are imperceptible at the human eye. The structured light may be projected in invisible light such as ultraviolet or infrared light, as the LED 210 may be an infrared LED or an ultraviolet LED.

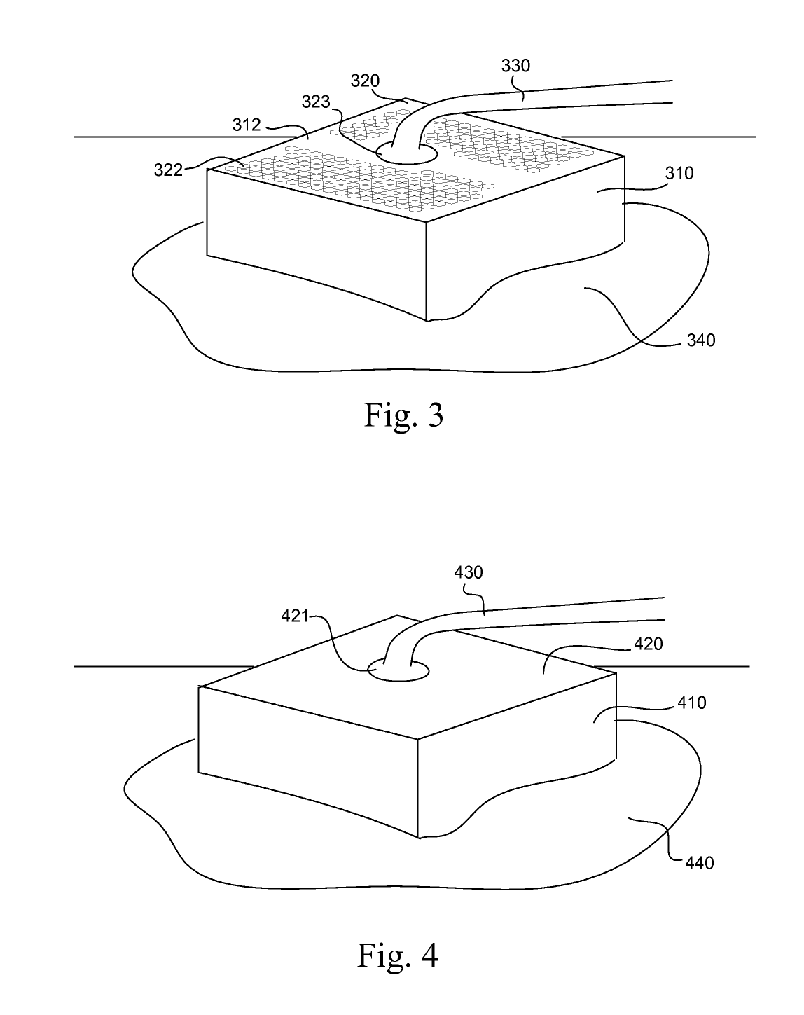

FIG. 3 shows one example of a light emitting diode 310. The pn-junction is formed between the contacts 330 and 340. In this example the surface 320 has a conducting area 312 and a thin layer providing conducting elements 323 and light emitting elements 322 side by side. The structures forming a contrast in the light of the LED 310 surface 320 are projected as features of the structured light. The surface 320 may comprise masked areas to enable desired shape for the structured light, wherein the mask may be part of the conducting area or a specific film applied to the surface 320.

FIG. 4 shows another example of a light emitting diode 410; in this example the LED 410 is a LPE Volume-Emitter diode. The pn-junction is formed between the contacts 440 and 430. The light emitting surface 420 and the conductor 421 form a sharp contrast that is projected as one feature of the structured light. The apparatus may comprise multiple LED elements on the same level having a similar distance to the projecting lens.

In one embodiment the apparatus comprises at least one processor and at least one memory including computer program code for one or more programs. The at least one memory and the computer program code are configured, with the at least one processor, to cause the apparatus to perform at least the following: projecting the structured light pattern on a first surface, receiving the structured light pattern and storing the structured light pattern in the at least one memory. The LED surface pattern is projected as structured light on the imaging area, wherein it is reflected from the first surface. The first surface may be any object on the imaging area, an object that is detected, recognized or whose distance to the projecting lens is to be calculated. The structured light may comprise multiple surface patterns or features that are projected onto multiple objects. An imaging device or a camera that is at a different position from the LED captures the image. The imaging device may be a separate device, wherein the captured image is sent to the apparatus analyzing the structured light when it is captured in the form it has been projected on the first surface. The imaging device may be implemented on the electronic device such as the mobile phone, a gaming console or a gaming console controller. The apparatus stores the received structured light image in the memory.

In one embodiment the camera is implemented in the apparatus, wherein it captures an image projected on the subject and the image comprises projected structured light. The apparatus detects at least a portion of the structured light pattern from the image and calculates the distance between the portion of the structured light pattern and the apparatus.

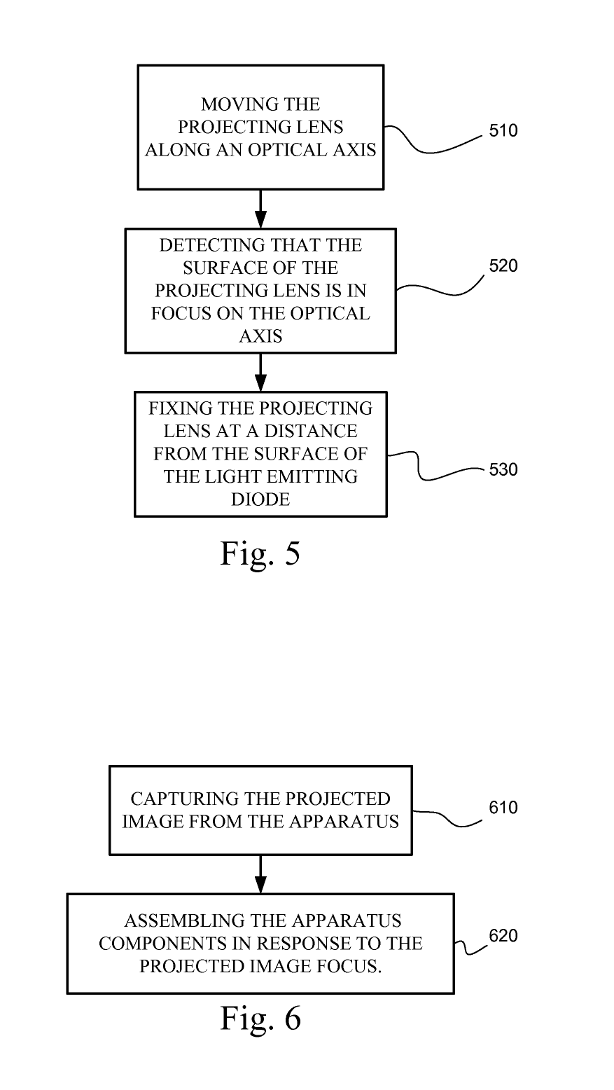

FIG. 5 is a schematic flowchart illustrating one embodiment of a method for manufacturing an apparatus or a system. A method is disclosed for manufacturing an apparatus comprising a light emitting diode having a surface and a projecting lens having a focal length. The method comprises moving the projecting lens along an optical axis, step 510; and fixing the projecting lens at a distance from the surface of the light emitting diode, step 530, when detecting that the surface of the projecting lens is in focus on the optical axis, step 520. FIG. 6 is a schematic flowchart illustrating one embodiment for active alignment of the components during assembly. In an embodiment the method comprises aligning components actively by capturing the projected image from the apparatus, step 610, and assembling the apparatus components in response to the projected image focus, step 620. A production batch of lenses may have different optical characteristics, for example the focal length may vary between individual lenses. The manufacturing process improves the positioning of the lens properly in relation to the LED surface. An imaging device is positioned on the optical axis when the installing machine attempts to find a correct position for the lens. The installing machine moves the lens along the optical axis until the imaging device detects that the image of the LED surface is in focus and fixes the lens in that position. In an embodiment the method comprises fixing the projecting lens at a distance of the focal length or a hyperfocal length from the surface of the light emitting diode.

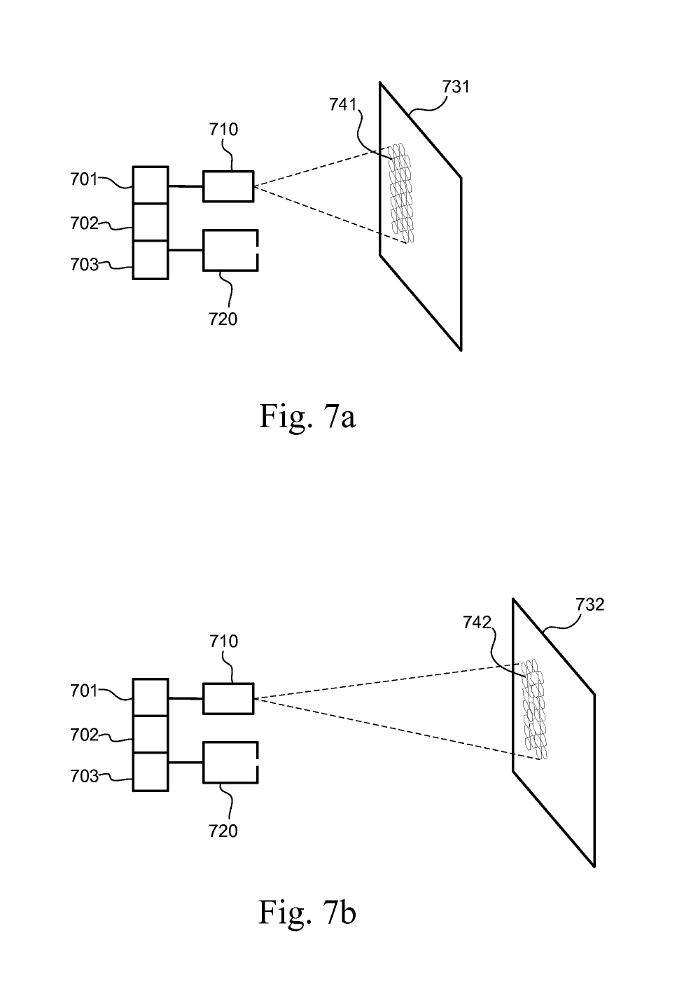

FIG. 7a shows a schematic diagram of one step of a method for calibrating the system or apparatus, wherein the structured light is projected to an object and FIG. 7b shows a schematic diagram of another step, wherein the object is in different position. In an embodiment of the method the apparatus comprises at least one processor 701 and at least one memory 702 including computer program code for one or more programs 703. The method comprises projecting the surface image 741 of the light emitting diode on a first surface 731 at a first distance from the projecting lens 710, receiving a first structured light pattern from the first surface image 741; and storing the first structured light pattern in the at least one memory 702. The first surface image 741 may be projected on a flat first surface 731. The first surface image 741 may be used as reference data for the structured light. In an embodiment the method comprises projecting the second surface image 742 of the light emitting diode on a second surface 732 at a second distance from the projecting lens 710, receiving a second structured light pattern from the second surface image 742, storing the second structured light pattern in the at least one memory 702 and calibrating a distance detecting module by comparing the first structured light pattern and the second structured light pattern. The second structured light pattern projected on the second surface 732, for example a flat surface, is captured as the second surface image 742 and used as the second reference data for the structured light. The projecting lens 710 may not be ideal, wherein at least a portion of the distortions are detected by analyzing the first surface image 741 and the second surface image 742. Said distortions and any other differences between the first surface image 741 and the second surface image 742 are stored in the memory 702 of the apparatus. The information may be used to calculate the depth information of a captured image having projected structured light. The structured light from the projected LED surface may be slightly different for every manufactured apparatus, electronic device or depth camera system; therefore, the structured light pattern may be stored in the memory and calibrated for more accurate depth calculation.

One aspect discloses a depth camera system comprising a light emitting diode having a surface and a projecting lens having a focal length, wherein the projecting lens is positioned at a distance of the focal length or a hyperfocal length from the surface of the light emitting diode and the projecting lens is configured to project an image of the surface of the light emitting diode. In an embodiment the surface of the light emitting diode comprises elements blocking the rays of light from traveling from the light emitting diode to the projecting lens, causing the projecting lens to project a structured light pattern. The depth camera system comprises at least one processor and at least one memory including computer program code for one or more programs. The at least one memory and the computer program code are configured, with the at least one processor, to cause the system to perform at least the following: projecting the structured light pattern on a surface, receiving the structured light pattern and storing the structured light pattern in the at least one memory. In an embodiment the depth camera system comprises an imaging apparatus, for example a camera. The computer program code is configured, with the at least one processor, to cause the camera to capture an image, detect at least a portion of the structured light pattern from the image and calculate the distance between the portion of the structured light pattern and the apparatus. The camera may be a portion of the system. In an embodiment the system comprises an image detector module configured to capture an image of the structured light as reflected from one or more objects within the capture area. The projecting lens and the camera or the image detector module are positioned at different positions, allowing the camera or the image detector module to detect the reflected light from a different angle from where it is projected.

One aspect discloses an apparatus, comprising: a light emitting diode having a surface; a projecting lens having a focal length, wherein the projecting lens is positioned at a distance of the focal length or a hyperfocal length from the surface of the light emitting diode; and the projecting lens is configured to project an image of the surface of the light emitting diode. In an embodiment the surface of the light emitting diode comprises elements configured to block a portion of rays of light from traveling from the light emitting diode to the projecting lens, and configured to cause the projecting lens to project a structured light pattern. In an embodiment the projecting lens is a collimating lens. In an embodiment the light emitting diode is selected from the group including an infrared light emitting diode, an ultraviolet light emitting diode and a visible light emitting diode. In an embodiment the group consists of an infrared light emitting diode, an ultraviolet light emitting diode and a visible light emitting diode. In an embodiment the apparatus comprises at least one processor; and at least one memory including computer program code for one or more programs, the at least one memory and the computer program code configured, with the at least one processor, to cause the apparatus to perform at least the following: projecting the structured light pattern on a first surface; receiving the structured light pattern; and storing the structured light pattern in the at least one memory. In an embodiment the apparatus comprises a camera; at least one processor; and at least one memory including computer program code for one or more programs, the at least one memory and the computer program code configured, with the at least one processor, to cause the apparatus to perform at least the following: the camera capturing an image; detecting at least a portion of the structured light pattern from the image; and calculating the distance between the portion of the structured light pattern and the apparatus.

One aspect discloses a method for manufacturing an apparatus; said method comprising: moving a projecting lens having a focal length along an optical axis; and fixing the projecting lens at a distance from a surface of a light emitting diode when detecting that the surface of the projecting lens is in focus on the optical axis. In an embodiment the projecting lens is a collimating lens. In an embodiment the light emitting diode is selected from the group including an infrared light emitting diode, an ultraviolet light emitting diode and a visible light emitting diode. In an embodiment the group consists of an infrared light emitting diode, an ultraviolet light emitting diode and a visible light emitting diode.

One aspect discloses a depth camera system, comprising: a light emitting diode having a surface; a projecting lens having a focal length; wherein the projecting lens is positioned at a distance of the focal length or a hyperfocal length from the surface of the light emitting diode; and the projecting lens is configured to project an image of the surface of the light emitting diode. In an embodiment the surface of the light emitting diode comprises elements blocking the rays of light from traveling from the light emitting diode to the projecting lens, causing the projecting lens to project a structured light pattern. In an embodiment the projecting lens is a collimating lens. In an embodiment the light emitting diode is selected from the group including an infrared light emitting diode, an ultraviolet light emitting diode and a visible light emitting diode. In an embodiment the group consists of an infrared light emitting diode, an ultraviolet light emitting diode and a visible light emitting diode. In an embodiment the depth camera system comprises at least one processor; and at least one memory including computer program code for one or more programs, the at least one memory and the computer program code configured, with the at least one processor, to cause the system to perform at least the following: projecting the structured light pattern on a first surface; receiving the structured light pattern; and storing the structured light pattern in the at least one memory. In an embodiment the depth camera system apparatus comprises a camera; at least one processor; and at least one memory including computer program code for one or more programs, the at least one memory and the computer program code configured, with the at least one processor, to cause the system to perform at least the following: the camera capturing an image; detecting at least a portion of the structured light pattern from the image; and calculating the distance between the portion of the structured light pattern and the apparatus. In an embodiment the depth camera system comprises an image detector module configured to capture an image of the structured light as reflected from one or more objects within the capture area.

Alternatively, or in addition, the functionality described herein can be performed, at least in part, by one or more hardware components or hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs). For example, some or all of the depth camera functionality, 3D imaging functionality or gesture detecting functionality may be performed by one or more hardware logic components.

An example of the apparatus or a system described hereinbefore is a computing-based device comprising one or more processors which may be microprocessors, controllers or any other suitable type of processors for processing computer executable instructions to control the operation of the device in order to control one or more sensors, receive sensor data and use the sensor data. Platform software comprising an operating system or any other suitable platform software may be provided at the computing-based device to enable application software to be executed on the device.

The computer executable instructions may be provided using any computer-readable media that is accessible by a computing based device. Computer-readable media may include, for example, computer storage media such as memory and communications media. Computer storage media, such as memory, includes volatile and non-volatile, removable and non-removable media implemented in any method or technology for storage of information such as computer readable instructions, data structures, program modules or other data. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media do not include communication media. Therefore, a computer storage medium should not be interpreted to be a propagating signal per se. Propagated signals may be present in computer storage media, but propagated signals per se are not examples of computer storage media. Although the computer storage media are shown within the computing-based device it will be appreciated that the storage may be distributed or located remotely and accessed via a network or other communication link, for example by using communication interface.

The computing-based device may comprise an input/output controller arranged to output display information to a display device which may be separate from or integral to the computing-based device. The display information may provide a graphical user interface, for example, to display hand gestures tracked by the device using the sensor input or for other display purposes. The input/output controller is also arranged to receive and process input from one or more devices, such as a user input device (e.g. a mouse, keyboard, camera, microphone or other sensor). In some examples the user input device may detect voice input, user gestures or other user actions and may provide a natural user interface (NUI). This user input may be used to configure the device for a particular user such as by receiving information about bone lengths of the user. In an embodiment the display device may also act as the user input device if it is a touch sensitive display device. The input/output controller may also output data to devices other than the display device, e.g. a locally connected printing device.

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not only include propagated signals. Propagated signals may be present in tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Alternatively, or in addition, the functionally described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

Any range or device value given herein may be extended or altered without losing the effect sought.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. An apparatus, comprising:
a light emitting diode having a surface;
a projecting lens having a focal length;
wherein the projecting lens is positioned at a distance of the focal length or a hyperfocal length from the surface of the light emitting diode;
and the projecting lens is configured to project an image of the surface of the light emitting diode.

2. An apparatus according to claim 1, wherein the surface of the light emitting diode comprises elements configured to block a portion of rays of light from traveling from the light emitting diode to the projecting lens, and configured to cause the projecting lens to project a structured light pattern.

3. An apparatus according to claim 1, wherein the projecting lens is a collimating lens.

4. An apparatus according to claim 1, wherein the light emitting diode is selected from the group including an infrared light emitting diode, an ultraviolet light emitting diode and a visible light emitting diode.

5. An apparatus according to claim 2, comprising:
at least one processor;
and at least one memory including computer program code for one or more programs, the at least one memory and the computer program code configured, with the at least one processor, to cause the apparatus to perform at least the following:
projecting the structured light pattern on a first surface;
receiving the structured light pattern; and
storing the structured light pattern in the at least one memory.

6. An apparatus according to claim 2, comprising:
a camera;
at least one processor;
and at least one memory including computer program code for one or more programs, the at least one memory and the computer program code configured, with the at least one processor, to cause the apparatus to perform at least the following:
the camera capturing an image;
detecting at least a portion of the structured light pattern from the image; and
calculating the distance between the portion of the structured light pattern and the apparatus.

7. A method for manufacturing an apparatus,
said method comprising:
moving a projecting lens having a focal length along an optical axis; and
fixing the projecting lens at a distance from a surface of a light emitting diode when detecting that the surface of the projecting lens is in focus on the optical axis.

8. A method according to claim 7, comprising aligning components actively by capturing the projected image from the apparatus and assembling the apparatus components in response to the projected image focus.

9. A method according to claim 7, comprising fixing the projecting lens at a distance of the focal length or a hyperfocal length from the surface of the light emitting diode.

10. A method according to claim 9, the apparatus comprising at least one processor and at least one memory including computer program code for one or more programs; and the method comprising:
projecting the surface image of the light emitting diode on a first surface at a first distance from the projecting lens;
receiving a first structured light pattern from the first surface image; and
storing the first structured light pattern in the at least one memory.

11. A method according to claim 9, the apparatus comprising at least one processor and at least one memory including computer program code for one or more programs; and the method comprising:
projecting the surface image of the light emitting diode on a second surface at a second distance from the projecting lens;
receiving a second structured light pattern from the second surface image;
storing the second structured light pattern in the at least one memory; and
calibrating a distance detecting module by comparing the first structured light pattern and the second structured light pattern.

12. A method according to claim 7, wherein the projecting lens is a collimating lens.

13. An method according to claim 7, wherein the light emitting diode is selected from the group including an infrared light emitting diode, an ultraviolet light emitting diode and a visible light emitting diode.

14. A depth camera system, comprising:
a light emitting diode having a surface;
a projecting lens having a focal length;
wherein the projecting lens is positioned at a distance of the focal length or a hyperfocal length from the surface of the light emitting diode;
and the projecting lens is configured to project an image of the surface of the light emitting diode.

15. A depth camera system according to claim 14, wherein the surface of the light emitting diode comprises elements configured to block a portion of rays of light from traveling from the light emitting diode to the projecting lens, configured to cause the projecting lens to project a structured light pattern.

16. A depth camera system according to claim 14, wherein the projecting lens is a collimating lens.

17. A depth camera system according to claim 14, wherein the light emitting diode is selected from the group including an infrared light emitting diode, an ultraviolet light emitting diode and a visible light emitting diode.

18. A depth camera system according to claim 15, comprising:
at least one processor;
and at least one memory including computer program code for one or more programs, the at least one memory and the computer program code configured, with the at least one processor, to cause the system to perform at least the following:
projecting the structured light pattern on a first surface;
receiving the structured light pattern; and
storing the structured light pattern in the at least one memory.

19. A depth camera system according to claim 15, comprising:
a camera;
at least one processor;
and at least one memory including computer program code for one or more programs, the at least one memory and the computer program code configured, with the at least one processor, to cause the system to perform at least the following:
the camera capturing an image;
detecting at least a portion of the structured light pattern from the image; and
calculating the distance between the portion of the structured light pattern and the apparatus.

20. A depth camera system according to claim 14, comprising an image detector module configured to capture an image of the structured light as reflected from one or more objects within the capture area.
